(19) United States
(12) Patent Application Publication
(10) Pub. No.: US 2023/0055862 A1
(43) Pub. Date: Feb. 23, 2023

(54) VEHICLE

(71) Applicant: TOYOTA JIDOSHA KABUSHIKI KAISHA, Toyota-shi (JP)

(72) Inventors: Takayuki HAMADA, Okazaki-shi (JP); Yuki OGAWA, Toyota-shi (JP); Masakazu AOKI, Nagoya-shi (JP); Yohsuke HASHIMOTO, Nagakute-shi (JP)

(73) Assignee: TOYOTA JIDOSHA KABUSHIKI KAISHA, Toyota-shi (JP)

(21) Appl. No.: 17/810,048

(22) Filed: Jun. 30, 2022

(30) Foreign Application Priority Data
Aug. 19, 2021 (JP) 2021-134296

(51) Int. Cl. G06V 20/58; G06T 11/00

(52) U.S. Cl. CPC G06V 20/58; G06T 11/00; G06V 2201/08; G06T 2210/21; B60K 35/00

(57) ABSTRACT

A vehicle includes an image capturing device configured to capture an image in a vehicle traveling direction, a display device, and a controller configured to carry out an analysis of the image captured by the image capturing device and display an indicator based on the analysis on the display device. The controller is configured to display a first object that approaches a host vehicle on the display device in a mode different from a mode for a second object that does not approach the host vehicle within the image captured by the image capturing device.

### CROSS-REFERENCE TO RELATED APPLICATION

This application claims priority to Japanese Patent Application No. 2021-134296 filed on Aug. 19, 2021, incorporated herein by reference in its entirety.

### BACKGROUND

### 1. Technical Field

The disclosure relates to a vehicle and, more specifically, to a vehicle that analyzes an obstacle from a captured image in a vehicle traveling direction.

### 2. Description of Related Art

There has been suggested a vehicle of this type (see, for example, Japanese Unexamined Patent Application Publication No. 2020-074504 (JP 2020-074504)). The vehicle acquires a captured image including an approaching object, generates a dynamic pattern added image in which a dynamic pattern of which a view on a display screen varies with a predetermined period is added to the approaching object in the captured image based on a determination result on a state of approach of the approaching object, and displays the generated dynamic pattern added image on the display screen. In this vehicle, a dynamic pattern with a different color is generated in accordance with the risk of an object or a dynamic pattern is generated such that the rate at which a view varies is varied in accordance with the risk of an object. Thus, the vehicle helps a driver more quickly and more accurately recognize an approaching object.

### SUMMARY

However, in the vehicle, when a dynamic pattern added image, that is, an image of an approaching object to which a dynamic pattern is added, is generated and displayed on a display screen, the dynamic pattern added image can be continuously displayed even when the object does not approach the host vehicle thereafter. In this case, the driver does not understand whether the object approaches the host vehicle or not and is not able to accurately recognize a surrounding situation.

The disclosure provides a vehicle that allows further proper recognition of an object that approaches the host vehicle and an object that does not approach the host vehicle.

An aspect of the disclosure provides a vehicle. The vehicle includes an image capturing device configured to capture an image in a vehicle traveling direction, a display device, and a controller configured to carry out an analysis of the image captured by the image capturing device and display an indicator based on the analysis on the display device. The controller is configured to display a first object that approaches the host vehicle on the display device in a mode different from a mode for a second object that does not approach the host vehicle within the image captured by the image capturing device. With the above configuration, it is possible to further properly recognize an object that approaches the host vehicle and an object that does not approach the host vehicle.

In the vehicle, the controller may be configured to display the first object that approaches the host vehicle on the display device with a decorative image as the indicator. With the above configuration, a driver is able to easily recognize that an object displayed with a decorative image is an object that approaches the host vehicle and an object displayed without a decorative image is an object that does not approach the host vehicle.

In the vehicle, the controller may be configured to display the first object that approaches the host vehicle on the display device in a mode that varies in accordance with a speed at which the first object approaches the host vehicle.

In the vehicle, the controller may be configured to, when a predetermined condition is satisfied, display the first object on the display device in a mode different from a mode for when the predetermined condition is not satisfied. The predetermined condition may be at least one of a case where the first object is a human and a case where there is a possibility of a collision with the first object.

In the vehicle, the controller may be configured to, when a lane change of another vehicle is analyzed from the image captured by the image capturing device, display a decorative image in a lane change direction of the other vehicle on the display device. It is possible to help a driver quickly recognize a lane change of another vehicle.

In the vehicle, the display device may be a center display, and the controller may be configured to display the decorative image on the display device together with the image captured by the image capturing device. With the above configuration, an image that incorporates a decorative image in a captured image containing an object that approaches the host vehicle is able to be displayed on the center display, so it is possible to help a driver further properly recognize an object that approaches the host vehicle and an object that does not approach the host vehicle.

In the vehicle, the display device may be a head-up display, and the controller may be configured to display the decorative image on the display device at a predetermined position with respect to the corresponding first object based on the image captured by the image capturing device. With the above configuration, a decorative image is able to be displayed on the head-up display at a predetermined position with respect to an object that is approaching the host vehicle and that is visually recognized by a driver, so it is possible to help the driver further properly recognize an object that approaches the host vehicle and an object that does not approach the host vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of the configuration of a vehicle according to an embodiment of the disclosure as blocks mainly including a main electronic control unit;

FIG. 2 is a flowchart showing an example of a decorated risk object display process that is executed by the main electronic control unit;

FIG. 3 is a table showing an example of a risk level, details, and decoration;

FIG. 4 is a view illustrating an example of an image decorated and displayed on a center display; and

FIG. 5 is a view illustrating an example of an image decorated and displayed on the center display.

### DETAILED DESCRIPTION OF EMBODIMENTS

An embodiment of the disclosure will be described.

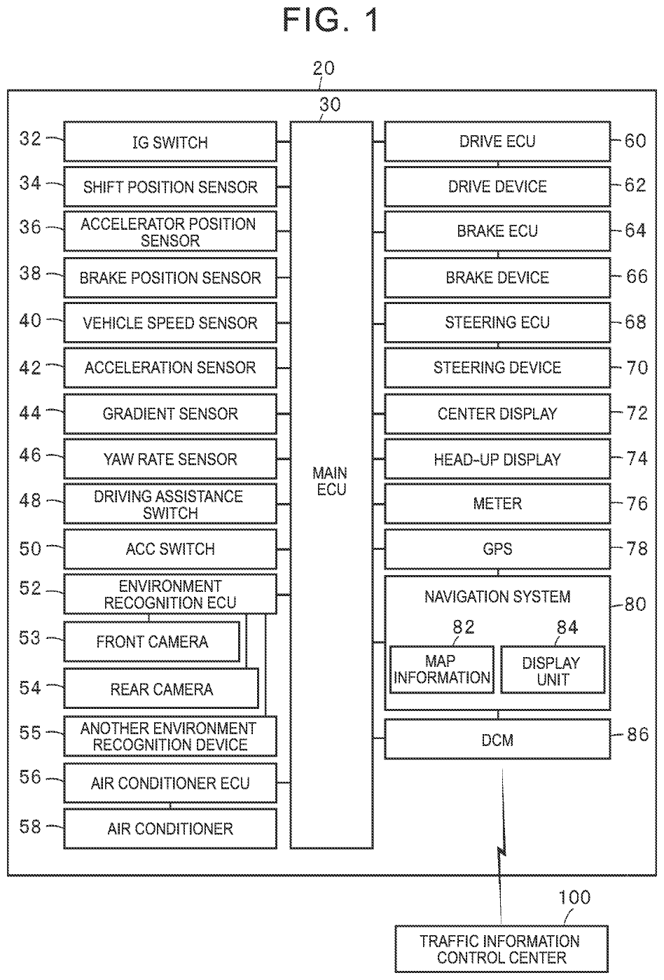

FIG. 1 is a block diagram showing an example of the configuration of a vehicle 20 according to the embodiment of the disclosure as blocks mainly including a main electronic control unit (hereinafter, referred to as main ECU) 30. As shown in the drawing, the vehicle 20 of the embodiment includes a drive device 62 that outputs driving force to drive wheels (not shown), and a drive electronic control unit (hereinafter, referred to as drive ECU) 60 for controlling the drive of the drive device 62.

A system that includes an engine and an automatic transmission, a hybrid system that includes an engine, a motor, and a battery, a fuel cell drive system that includes a fuel cell, a battery, and a motor, an electrified system that includes a battery and a motor, or the like may be used as the drive device 62.

Although not shown in the drawing, the drive ECU 60 is a microcomputer that mainly includes a CPU and that, in addition to the CPU, further includes a ROM, a RAM, a flash memory, an input port, an output port, a communication port, and the like. The drive ECU 60 controls the drive of the drive device 62 based on a drive control signal from the main ECU 30.

The vehicle 20 of the embodiment, in addition to the drive device 62 and the drive ECU 60, includes an ignition switch 32, a shift position sensor 34, an accelerator position sensor 36, a brake position sensor 38, a vehicle speed sensor 40, an acceleration sensor 42, a gradient sensor 44, a yaw rate sensor 46, a driving assistance switch 48, an autocruise control switch (hereinafter, referred to as ACC switch) 50, an environment recognition electronic control unit (hereinafter, referred to as environment recognition ECU) 52, a front camera 53, a rear camera 54, another environment recognition device 55, an air conditioner electronic control unit (hereinafter, referred to as air conditioner ECU) 56, an air conditioner 58, a brake electronic control unit (hereinafter, referred to as brake ECU) 64, a brake device 66, a steering electronic control unit (hereinafter, referred to as steering ECU) 68, a steering device 70, a center display 72, a head-up display 74, a meter 76, a global positioning system or global positioning satellite (GPS) 78, a navigation system 80, a data communication module (DCM) 86, and the like.

The shift position sensor 34 detects the position of a shift lever. The accelerator position sensor 36 detects an accelerator operation amount or the like according to the depression amount of an accelerator pedal by a driver. The brake position sensor 38 detects a brake position or the like as the depression amount of a brake pedal by the driver.

The vehicle speed sensor 40 detects the vehicle speed of the vehicle based on wheel speeds or the like. The acceleration sensor 42 detects, for example, the acceleration of the vehicle in a front and rear direction. The gradient sensor 44 detects a road gradient. The yaw rate sensor 46 detects a lateral acceleration in a right and left direction (yaw rate) caused by turning motion.

The driving assistance switch 48 is a switch with which whether to display a decorated risk object as one driving assistance control. Displaying a decorated risk object will be described later. The ACC switch 50 is a switch to select whether to execute autocruise control as one driving assistance control. The driving assistance switch 48 and the ACC switch 50 are installed on a steering wheel, in an installation panel in front of a driver seat, or near the steering wheel or the installation panel.

Although not shown in the drawing, the environment recognition ECU 52 is configured as a microprocessor that mainly includes a CPU and that, in addition to the CPU, further includes a ROM that stores process programs, a RAM that temporarily stores data, input and output ports, and a communication port. Captured images from the front camera 53 that captures an image ahead of the vehicle and the rear camera 54 that captures an image behind the vehicle, and information on the host vehicle and its surroundings (for example, an inter-vehicle distance D1 from another vehicle ahead of the host vehicle, an inter-vehicle distance D2 from another vehicle behind the host vehicle, the vehicle speed of another vehicle, a running position of the host vehicle in lanes on a road, and the like) from another environment recognition device 55 are input to the environment recognition ECU 52 via the input port. Examples of the other environment recognition device 55 may include a millimeter-wave radar, a submillimeter-wave radar, an infrared laser radar, and a sonar.

Although not shown in the drawing, the air conditioner ECU 56 is a microcomputer that mainly includes a CPU and that, in addition to the CPU, further includes a ROM, a RAM, a flash memory, an input port, an output port, a communication port, and the like. The air conditioner ECU 56 is incorporated in the air conditioner 58 that air-conditions a passenger compartment and controls the drive of an air conditioner compressor and the like in the air conditioner 58 such that the temperature of the passenger compartment becomes a set temperature.

Although not shown in the drawing, the brake ECU 64 is a microcomputer that mainly includes a CPU and that, in addition to the CPU, further includes a ROM, a RAM, a flash memory, an input port, an output port, a communication port, and the like. The brake ECU 64 controls the drive of the known hydraulically-driven brake device 66. The brake device 66 is configured to be capable of providing braking force caused by brake depression force generated by depression of the brake pedal and braking force caused by hydraulic adjustment.

Although not shown in the drawing, the steering ECU 68 is a microcomputer that mainly includes a CPU and that, in addition to the CPU, further includes a ROM, a RAM, a flash memory, an input port, an output port, a communication port, and the like. The steering ECU 68 controls the drive of an actuator of the steering device 28 in which the steering wheel and the drive wheels (not shown) are mechanically connected via a steering shaft. The steering device 28 steers the drive wheels based on driver's steering operation and steers the drive wheels by the actuator driven by the steering ECU 68 based on a steering control signal from the main electronic control unit 30.

The center display 72 is disposed in the center in front of a driver seat and a front passenger seat, also functions as a touch panel, and runs applications of various settings of the vehicle, audio, and various media and functions as a display unit 84 of the navigation system to perform map navigation.

The head-up display 74 provides an image (that is formed at an infinite point) on information for the driver on a windshield and displays, for example, a speed and a navigation guide. The meter 76 is incorporated in, for example, the installation panel in front of the driver seat.

The GPS 78 is a device that detects the location of the vehicle based on signals transmitted from a plurality of GPS satellites.

The navigation system 80 is a system that guides the host vehicle to a set destination and that includes map information 82 and the display unit 84. The navigation system 80 communicates with a traffic information control center 100 via the data communication module (DCM) 86, acquires road traffic information or acquires map information as needed to update the map information 82. When a destination is set, the navigation system 80 sets a route based on information on the destination, information on the current location (the current location of the host vehicle) acquired by the GPS 78, and the map information 82.

The data communication module (DCM) 86 transmits information on the host vehicle to the traffic information control center 100 or receives road traffic information from the traffic information control center 100. Examples of the information on the host vehicle include the location of the host vehicle, vehicle speed, drive power, and drive mode. Examples of the road traffic information include information on current or future traffic congestion, information on a current average vehicle speed or a predicted value of a future average vehicle speed in a section on a travel route, information on traffic regulation, information on weather, information on a road surface condition, and information on a map. The DCM 86 communicates with the traffic information control center 100 at predetermined intervals (for example, every 30 seconds, every minute, every two minutes, or the like).

Although not shown in the drawing, the main electronic control unit 30 is a microcomputer that mainly includes a CPU and that, in addition to the CPU, further includes a ROM, a RAM, a flash memory, an input port, an output port, a communication port, and the like. Various signals are input to the main electronic control unit 30 via the input port. Examples of the information to be input via the input port include an ignition switch signal from the ignition switch 32, a shift position from the shift position sensor 34, an accelerator operation amount from the accelerator position sensor 36, and a brake position from the brake position sensor 38. Examples of the information to be input via the input port may include a vehicle speed V from the vehicle speed sensor 40, an acceleration from the acceleration sensor 42, a gradient from the gradient sensor 44, and a yaw rate from the yaw rate sensor 46. Examples of the information to be input via the input port may include an autonomous driving instruction signal from the driving assistance switch 48 and an ACC instruction signal from the ACC switch 50. Various signals are output from the main electronic control unit 30 via the output port. Examples of the information to be output via the output port include a display control signal to the center display 72, a display control signal to the head-up display 74, and a display signal to the meter 76.

The main electronic control unit 30 communicates with the environment recognition ECU 52, the air conditioner ECU 56, the drive ECU 60, the brake ECU 64, the steering ECU 68, and the navigation system 80 and exchanges various information.

The main electronic control unit 30 sets a required driving force and a required power based on the accelerator operation amount from the accelerator position sensor 36 and the vehicle speed from the vehicle speed sensor 40 and transmits a drive control signal to the drive ECU 60 such that the required driving force and the required power are output from the drive device 62 to the vehicle.

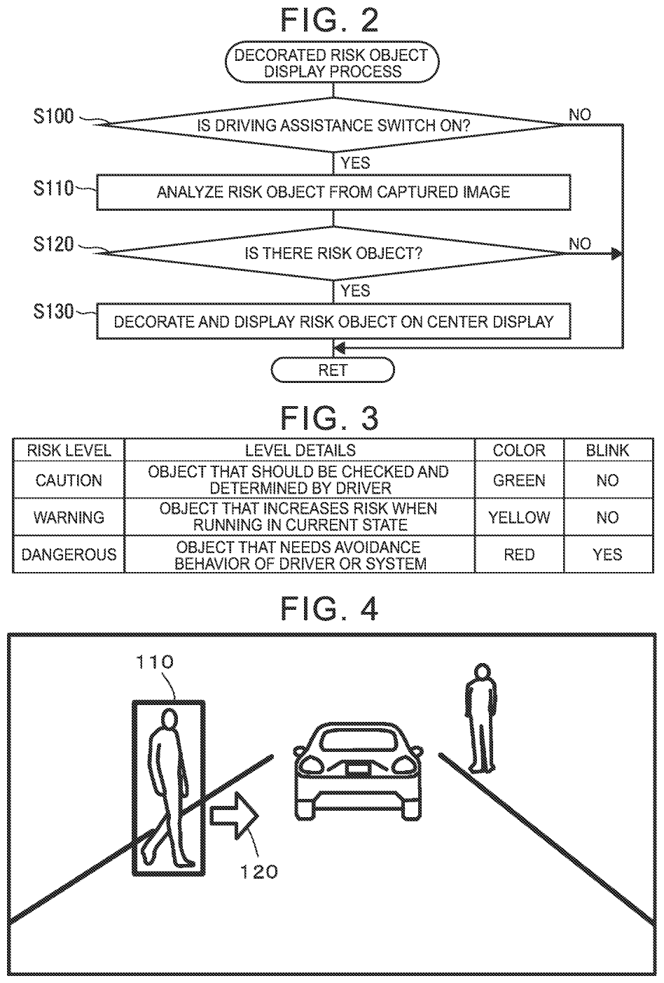

Next, the operation of the vehicle 20, particularly, the operation at the time of displaying a decorated risk object by turning on the driving assistance switch 48 will be described. FIG. 2 is a flowchart showing an example of the decorated risk object display process that is executed by the main electronic control unit 30. The decorated risk object display process is repeatedly executed while the driving assistance switch 48 is on.

When the decorated risk object display process is executed, the main electronic control unit 30 initially determines whether the driving assistance switch 48 is on (step S100). When the main electronic control unit 30 determines that the driving assistance switch 48 is off, the main electronic control unit 30 does not need to decorate and display the image of the risk object, so the main electronic control unit 30 ends the process.

When the main electronic control unit 30 determines in step S100 that the driving assistance switch 48 is on, the main electronic control unit 30 analyzes whether there is a risk object in a captured image captured by a camera in the traveling direction (step S110). An image captured by the front camera 53 is used as a captured image when the shift position is D position, and an image captured by the rear camera 54 is used as a captured image when the shift position is R position. The risk object is an object that is determined to approach the host vehicle based on the moving direction and the moving speed through an analysis of a captured image among objects in the captured image. Specifically, a human, a bicycle, a motorcycle, a vehicle, or the like that is determined to approach the host vehicle corresponds to the risk object.

When the main electronic control unit 30 analyzes whether there is a risk object in this way, the main electronic control unit 30 determines whether there is a risk object in the captured image as the result (step S120). When the main electronic control unit 30 determines that there is no risk object in the captured image, there is no object to be decorated, so the main electronic control unit 30 ends the process. On the other hand, when the main electronic control unit 30 determines that there is a risk object in the captured image, the main electronic control unit 30 decorates the risk object in the captured image according to a risk level and displays the captured image on the center display 72 (step S130), and ends the process. In other words, the main electronic control unit 30 decorates an object that is determined to approach the host vehicle, does not decorate an object that is determined not to approach the host vehicle, and displays the captured image on the center display 72.

For the risk level and the details of decoration, for example, as shown in the table of FIG. 3, an object that should be checked and determined by the driver corresponds to the one with a risk level “caution”, and examples of the object include a pedestrian walking on a sidewalk, a bicycle running on a roadway on the opposite side to the host vehicle in an opposite direction to the host vehicle, and a relatively distant object. In this case, a green rectangular frame image (decorative image) surrounding an object, such as a pedestrian and a bicycle, may be used without blinking as a decorative image. An object from which the risk increases when running in a current state corresponds to an object with a risk level “warning”, and examples of the object include a pedestrian walking on a road shoulder at a certain distance, a pedestrian at an intersection, a bicycle running on a roadway in the same direction as the host vehicle at a certain distance, and a relatively close object. In this case, a yellow rectangular frame image (decorative image) surrounding an object, such as a pedestrian and a bicycle, may be used without blinking as a decorative image, a yellow arrow image (decorative image) in a moving direction of an object may be used without blinking as a decorative image, or the like. An object that needs avoidance behavior of the driver or activation of avoidance behavior by the system corresponds to an object from which the risk level is “dangerous”, and examples of the object include a pedestrian that walks in a roadway direction at a close distance, a bicycle that runs on a roadway at a closes distance, and an object that seems to collide with the host vehicle. In this case, a red rectangular frame image (decorative image) surrounding an object, such as a pedestrian and a bicycle, may be used with blinking as a decorative image, a red arrow image (decorative image) in a moving direction of an object may be used with blinking as a decorative image, or the like.

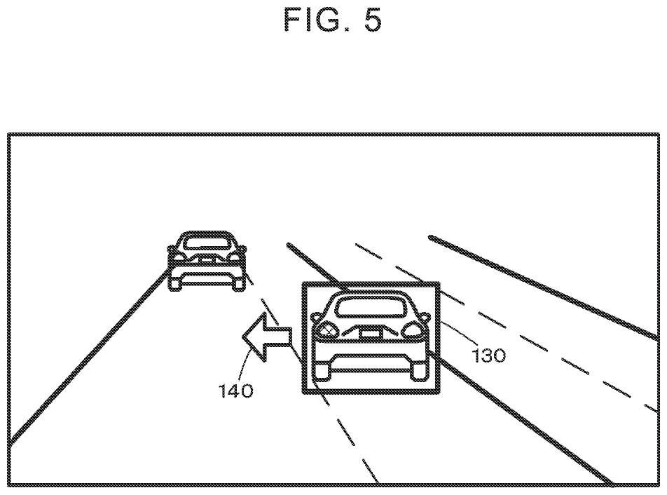

FIG. 4 is a view illustrating an example of an image decorated and displayed on the center display 72. In the drawing, a red rectangular frame indication image 110 and an arrow indication image 120 indicating a walking direction are displayed on the center display 72 as decorative images together with a captured image for a pedestrian that walks from the left toward a roadway. On the other hand, no decorative image is displayed for the upper right pedestrian because the pedestrian is away at a certain distance. By displaying a risk object on the center display 72 with the decorative images 110, 120 in this way, it is possible to prompt the driver to avoid the risk. No decorative image is displayed for an object other than a risk object, so the driver is able to further properly recognize an object that approaches the host vehicle and an object that does not approach the host vehicle. FIG. 5 is a view illustrating an example of an image decorated and displayed on the center display 72 when another vehicle is trying to make a lane change to a lane in which the host vehicle is running. In the drawing, a yellow rectangular frame decorative image 130 surrounding another vehicle trying to make a lane change and a yellow arrow indication image 140 indicating the direction of the lane change of the other vehicle are displayed. When another vehicle makes a lane change to the lane in which the host vehicle is running, the risk level (caution, warning, or dangerous) may be determined based on the inter-vehicle distance and relative speed between the other vehicle and the host vehicle, and the decorative images 130, 140 may be displayed. A determination as to whether another vehicle is trying to make a lane change to a lane in which the host vehicle is running can be analyzed by using the motion of the other vehicle, the status of direction indicators, and the like. When another vehicle overtakes the host vehicle and makes a lane change to the lane of the host vehicle, the other vehicle is not determined as a risk object when the inter-vehicle distance is longer than or equal to a certain distance, so the decorative images 130, 140 do not need to be displayed.

The risk level may be changed according to the relative speed between the host vehicle and a risk object. For example, even when the inter-vehicle distance between the host vehicle and a risk object is the same, the risk level is raised as the relative speed increases. The risk level may be changed according to time of a day, such as during daytime, at dawn, in the evening, and at night. For example, it is conceivable to extend the distance between the host vehicle and an object for the same risk level in ascending order of during daytime, at dawn, in the evening, and at night. The risk level may be changed according to weather, such as during clear weather, during cloudy weather, during rainy weather, and during snowy weather. For example, it is conceivable to extend the distance between the host vehicle and an object for the same risk level in ascending order of during clear weather, during cloudy weather, during rainy weather, and during snowy weather.

The risk level may be changed according to an object. When, for example, a risk object is a human or there is a possibility of a collision with a risk object, it is conceivable to raise the risk level as compared to other cases, raise the risk level of a child pedestrian or an elderly pedestrian as compared to an adult pedestrian, or raise the risk level of a bicycle as compared to a pedestrian.

In the vehicle 20 of the above-described embodiment, when the driving assistance switch 48 is on, whether there is a risk object in a captured image captured by the camera in the traveling direction is analyzed. Then, a decorative image is added to an object that is determined to approach the host vehicle, no decorative image is added to an object that is determined not to approach the host vehicle, and the captured image is displayed on the center display 72. Thus, it is possible to further properly recognize an object that approaches the host vehicle and an object that does not approach the host vehicle. In addition, a decorative image is displayed on the center display 72 while the color of the decorative image is changed or the decorative image is blinked according to the risk level “caution”, “warning”, or “dangerous”, so it is possible to inform the driver of the level of risk.

In the vehicle 20 of the embodiment, for a risk object that is determined to approach the host vehicle, a rectangular frame decorative image surrounding the risk object and an arrow decorative image indicating the moving direction of the risk object are displayed. Alternatively, only one of a rectangular frame decorative image surrounding the risk object and an arrow decorative image indicating the moving direction of the risk object may be displayed. A frame decorative image surrounding a risk object is not limited to a rectangular frame image and may be various shape frame images, such as an elliptical frame image and a polygonal frame image.

In the vehicle 20 of the embodiment, a decorative image is added to an object that is determined to approach the host vehicle, no decorative image is added to an object that is determined not to approach the host vehicle, and a captured image is displayed on the center display 72. Alternatively, the position of an object on a windshield, which is determined to approach the host vehicle, may be determined, and a decorative image may be displayed on the head-up display 74 so as to be added to the object.

In the vehicle 20 of the embodiment, the devices are controlled by the plurality of electronic control units, that is, the main electronic control unit 30, the environment recognition ECU 52, the drive ECU 60, the brake ECU 64, and the steering ECU 68. Alternatively, the devices may be controlled by a single electronic control unit or the devices may be controlled by using a plurality of electronic control units that also serve as some of the above electronic control units.

The correspondence relation between major elements of the embodiment and major elements of the disclosure described in Summary of the Disclosure will be described. The front camera 53 or the rear camera 54 is an example of the “image capturing device”, the center display 72 or the head-up display 74 is an example of the “display device”, and the main electronic control unit 30, the environment recognition ECU 52, and the like are an example of the “controller”.

The “object that approaches the host vehicle” mainly includes an object that is likely to collide with the host vehicle when the operations of the host vehicle and the object continue. Examples of the decorative image include a rectangular or elliptical frame image and an arrow image indicating the moving direction of an object. In this case, an object that does not approach the host vehicle may be displayed on the display device in a mode in which no decorative image is used. Examples of the method of displaying the first object that approaches the host vehicle on the display device in a different mode according to the speed at which the first object approaches the host vehicle include changing the color of a decorative image according to the speed at which an object approaches the host vehicle and changing the speed at which a decorative image blinks. For changing the color of a decorative image, for example, the color may be set to yellowish green when the speed at which an object approaches the host vehicle is low, the color may be set to yellow when the speed at which an object approaches the host vehicle is relatively high, and the color may be set to red when the speed at which an object approaches the host vehicle is fast. For changing the speed at which a decorative image blinks, for example, a decorative image may blink slowly when the speed at which an object approaches the host vehicle is low, a decorative image may blink relatively quickly when the speed at which an object approaches the host vehicle is relatively high, and a decorative image may blink quickly when the speed at which an object approaches the host vehicle is fast. Examples of the method of, when a predetermined condition is satisfied, displaying an image on the display device in a mode different from a mode in which the predetermined condition is not satisfied may include various modes. For example, a mode in which a red decorative image is displayed on the display device so as to blink quickly when an object is a human or there is a possibility of collision with an object; in other cases, a yellowish green or yellow decorative image is displayed on the display device without blinking.

The correspondence relation between major elements of the embodiment and major elements of the disclosure described in Summary does not limit the elements of the disclosure described in the Summary since the embodiment is an example for specifically describing the aspect of the disclosure described in the Summary. In other words, the aspect of the disclosure described in the Summary should be interpreted based on the description therein, and the embodiment is only a specific example of the aspect of the disclosure described in the Summary.

The embodiment of the disclosure is described above; however, the disclosure is not limited to the embodiment and may be, of course, modified into various forms without departing from the scope of the disclosure.

The disclosure is usable in the industry of manufacturing vehicles.

What is claimed is:

1. A vehicle comprising:
an image capturing device configured to capture an image in a vehicle traveling direction;
a display device; and
a controller configured to carry out an analysis of the image captured by the image capturing device and display an indicator based on the analysis on the display device, wherein the controller is configured to display a first object that approaches the host vehicle on the display device in a mode different from a mode for a second object that does not approach the host vehicle within the image captured by the image capturing device.

2. The vehicle according to claim 1, wherein the controller is configured to display the first object that approaches the host vehicle on the display device with a decorative image as the indicator.

3. The vehicle according to claim 2, wherein the controller is configured to display the first object that approaches the host vehicle on the display device in a mode that varies in accordance with a speed at which the first object approaches the host vehicle.

4. The vehicle according to claim 2, wherein the controller is configured to, when a predetermined condition is satisfied, display the first object on the display device in a mode different from a mode for when the predetermined condition is not satisfied, the predetermined condition is at least one of a case where the first object is a human and a case where there is a possibility of a collision with the first object.

5. The vehicle according to claim 1, wherein the controller is configured to, when a lane change of another vehicle is analyzed from the image captured by the image capturing device, display a decorative image in a lane change direction of the other vehicle on the display device.

6. The vehicle according to claim 2, wherein:
the display device is a center display; and
the controller is configured to display the decorative image on the display device together with the image captured by the image capturing device.

7. The vehicle according to claim 2, wherein:
the display device is a head-up display; and
the controller is configured to display the decorative image on the display device at a predetermined position with respect to the corresponding first object based on the image captured by the image capturing device.
